(19) United States
(12) Patent Application Publication
(10) Pub. No.: US 2010/0122023 A1
(43) Pub. Date: May 13, 2010

(54) PORTABLE ELECTRONIC DEVICE AND METHOD FOR PROTECTING DATA OF THE PORTABLE ELECTRONIC DEVICE

(75) Inventor: PI-FENG SHIH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/495,871

(22) Filed: Jul. 1, 2009

(30) Foreign Application Priority Data
Nov. 12, 2008 (CN) 200810305500.0

(51) Int. Cl. G06F 12/00

(52) U.S. Cl. 711/104; 711/E12.001; 711/162

(57) ABSTRACT

A portable electronic device includes a random access memory, a non-volatile random access memory, a detecting unit, and a processing unit. The detecting unit is configured to detect an acceleration of the portable electronic device. The processing unit is configured to compare a value of the acceleration of the portable electronic device with a predetermined parameter. If the value of the acceleration is greater or equal to the predetermined parameter, data is copied from the random access memory to the non-volatile random access memory.

### BACKGROUND

1. Technical Field

The present disclosure relates to a portable electronic device and a method for protecting data of the portable electronic device.

2. Description of the Related Art

Generally, a battery of a portable electronic device, such as a cell phone, is easily detached from the portable electronic device when the portable electronic device drops and hits the ground. As a result, programs running in the portable electronic device stop running.

To solve this problem, a protect module is positioned in the portable electronic device. The protect module includes an electric current detecting module. The electric current detecting module is used to detect a change of a voltage of the electric current in a circuit of the portable electronic device.

When the voltage drops rapidly, the portable electronic device is in a status that the electric current will break soon. Then a spare battery works and supplies power to the portable electronic device to save data.

That is a passive protect module, in other words, only after the voltage is detected, the spare battery can work and supply power. Sometime, the protect module cannot response in such short time, therefore, data is easily lost.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 is a schematic view of an embodiment of the portable electronic device.

FIGS. 2-1 and 2-2 are flow charts of a method for protecting data of the portable electronic device in FIG. 1 when the portable electronic device has been dropped.

### DETAILED DESCRIPTION

The portable electronic device of the present disclosure may be a media player, a cell phone, a notebook computer, and so on.

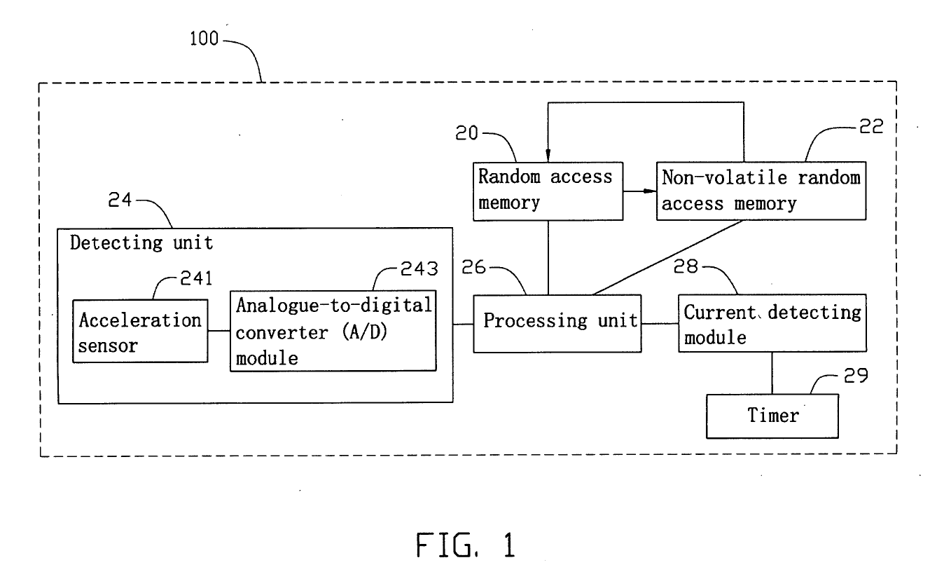

Referring to FIG. 1, an embodiment of the portable electronic device 100 includes a random access memory 20, a non-volatile random access memory 22, a detecting unit 24, and a processing unit 26.

The random access memory 20 is configured for storing data temporarily to enhance data transfer speed between a central processing unit (CPU, not shown) and the non-volatile random access memory 22 directly. The random access memory 20 may be a dynamic random access memory (DRAM), or a static random access memory (SRAM), etc.

The non-volatile random access memory 22 may be a flash memory. The non-volatile random access memory 22 is configured for storing data permanently, thereby preventing data loss due to a discontinued electric current.

The detecting unit 24 includes an acceleration sensor 241 and an analogue-to-digital converter (A/D) module 243. The acceleration sensor 241 is configured for detecting an acceleration of the portable electronic device 100, and the A/D module 243 is configured for converting an analog signal corresponding the acceleration of the portable electronic device 100 to a digital acceleration value, and sending the digital acceleration value to the processing unit 26.

The processing unit 26 is configured for processing the digital acceleration value. A predetermined parameter is stored in the processing unit 26. When the processing unit 26 receives the digital acceleration value from the detecting unit 24, the processing unit 26 compares the digital acceleration value with the predetermined parameter. It can be understood that, the processing unit 26 may be a separated module or a part of the CPU.

If a value of the digital acceleration value from the detecting unit 24 is greater than or equal to the predetermined parameter, the CPU computes that the portable electronic device 100 is in a danger status such as in free fall. Then, a backup data instruction that copies data from the random access memory 20 to the non-volatile random access memory 22 is sent from the detecting unit 24 to the CPU. As a result, data in the random access memory 20 is copied and stored to the non-volatile random access memory 22. Therefore, in a result that the portable electronic device 100 hits the ground, and, disrupts the electric current, causing data to be lost from the random access memory 20, data can still be retrieved because it has already been copied to the non-volatile random access memory 22, thereby preventing data loss.

If the value of the digital acceleration value from the detecting unit 24 is smaller than the predetermined parameter, the CPU computes that the portable electronic device 100 is in a normal status. Then, the portable electronic device 100 continues to operate normally.

Furthermore, an electric current detecting module 28 may be configured for detecting whether an electric current is present in the portable electronic device 100 and sends the electric current information to the CPU, and a timer 29 may be configured to track a time that the electric current detecting module 28 has been in operation.

When the backup data instruction is sent to the CPU, the electric current detecting module 28 is activated. The electric current detecting module 28 sends the information indicating whether electric current is present in the circuits to the CPU, periodically every second.

If the electric current is present over a period such as 10 seconds continuously, the CPU computes that the portable electronic device 100 is in a normal status. The portable electronic device 100 continues to operate normally.

If the electric current is not present, the CPU computes that the portable electronic device 100 is in a danger status, then the electric current detecting module 28 continues to detect for electric current. After a predetermined time such as 20 seconds, if electric current is present, the electric current detecting module 28 sends a current detected signal to the CPU, the CPU computes that the portable electronic device 100 is in a battery connected status, then a restore data instruction that copies the backup data in the non-volatile random access memory 22 to the random access memory 20 is sent to the CPU. The portable electronic device 100 resumes.

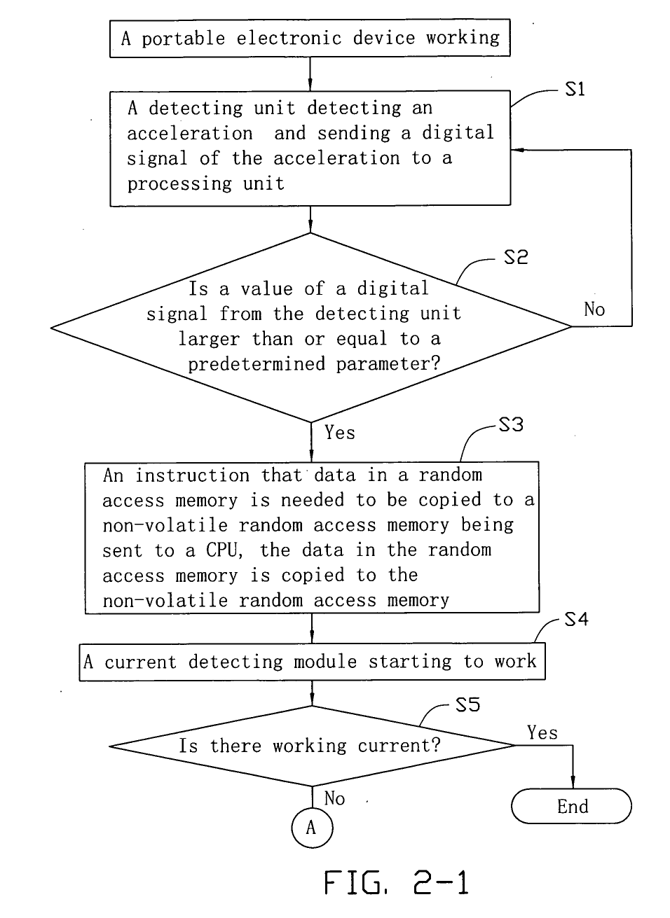

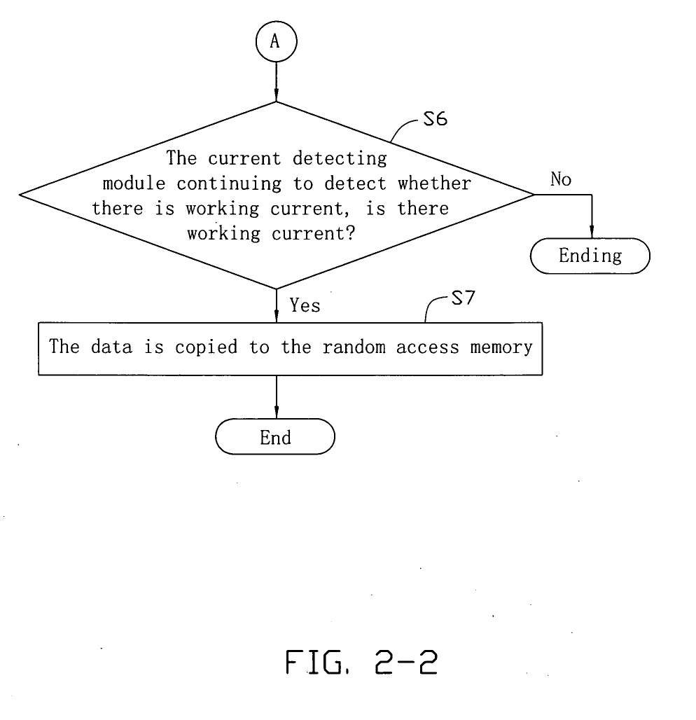

Referring to FIGS. 2-1 and 2-2, a flow chart of a method of protecting data of the portable electronic device 100 is shown.

In step S1, the detecting unit 24 detects the acceleration of the portable electronic device 100, and converts an analog signal corresponding the acceleration of the portable electronic device 100 to a digital acceleration value, and sends the digital acceleration value to the processing unit 26.

In step S2, the processing unit 26 compares the digital acceleration value with the predetermined parameter in the processing unit 26. If a value of the digital acceleration value from the detecting unit 24 is greater than or equal to the predetermined parameter, then the step S3 is executed. If the digital acceleration value from the detecting unit 24 is smaller than the predetermined parameter, returns to step S1, continuing to detect.

In step S3, the backup data instruction is sent to the CPU. The data is retrieved from random access memory and transferred to non-volatile random access memory.

In step S4, the electric current detecting module 28 is activated.

In step S5, the electric current detecting module 28 detects for electric current. If electric current is detected, the electric current detecting module 28 is deactivated. If electric current is not detected, the step S6 is executed.

In step S6, the electric current detecting module 28 continues to detect for electric current, when electric current is detected, executes the step S7. If electric current is not detected for at least a predetermined time such as 60 seconds, the portable electronic device 100 is in a no power supply mode, i.e., the battery is malfunctioning or detached from the main body and is unable to supply power, the electric current detecting module 28 then deactivates.

In step S7, the data in the non-volatile random access memory 22 is copied to the random access memory 20.

Finally, while various embodiments have been described and illustrated, the embodiments are not to be construed as being limited thereto. Various modifications can be made to the embodiments by those skilled in the art without departing from the true spirit and scope of the disclosure as defined by the appended claims.

What is claimed is:

1. A portable electronic device, comprising:
a random access memory;
a non-volatile random access memory;
a detecting unit to detect an acceleration of the portable electronic device; and
a processing unit to compare a value of the acceleration of the portable electronic device with a predetermined parameter, and wherein if the value of the acceleration is greater or equal to the predetermined parameter, a backup data instruction copies data from the random access memory to the non-volatile random access memory.

2. The portable electronic device as claimed in claim 1, wherein the predetermined value is stored in the processing unit.

3. The portable electronic device as claimed in claim 1, wherein the random access memory is a dynamic random access memory or a static random access memory.

4. The portable electronic device as claimed in claim 1, wherein the non-volatile random access memory is a flash memory.

5. The portable electronic device as claimed in claim 1, wherein the detecting unit comprises an acceleration sensor and an A/D module, the acceleration sensor detects the acceleration of the portable electronic device, the A/D module converts an analog signal corresponding to the acceleration of the portable electronic device into digital acceleration value.

6. The portable electronic device as claimed in claim 1, further comprising an electric current detecting module, wherein the electric current detecting module detects whether electric current is present in the portable electronic device and sends a signal indicating whether electric current is present in the circuits to a CPU; the CPU decides whether to copy the backup data to the non-volatile random access memory according to the information.

7. The portable electronic device as claimed in claim 1, wherein the processing unit is a part of the CPU.

8. The portable electronic device as claimed in claim 6, wherein the electric current detecting module periodically detects whether electric current is present in the portable electronic device.

9. A method for protecting data of a portable electronic device having a random access memory and a non-volatile random access memory, comprising:
detecting an acceleration of the portable electronic device;
comparing a value of the acceleration of the portable electronic device with a predetermined parameter, and if a value of the acceleration is greater or equal to the predetermined parameter, copying data from the random access memory to the non-volatile random access memory.

10. The method as claimed in claim 9, further comprising a step of detecting electric current in the portable electronic device if a value of the acceleration is greater or equal to the predetermined parameter.

11. The method as claimed in claim 10, further comprising a step of copying the data in the non-volatile random access memory to the random access memory if electric current is present in the portable electronic device.
